(19) United States
(12) Patent Application Publication
(10) Pub. No.: US 2009/0274612 A1
(43) Pub. Date: Nov. 5, 2009

(54) PROCESS FOR PRODUCING SUPPORTED RUTHENIUM OXIDE AND PROCESS FOR PRODUCING CHLORINE

(75) Inventor: Kohei Seki, Ehime (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited., Chuo-ku, Tokyo (JP)

(21) Appl. No.: 11/910,273

(22) PCT Filed: Apr. 7, 2006
(86) PCT No.: PCT/JP2006/007876

§ 371 Date: Oct. 1, 2007

(30) Foreign Application Priority Data
Apr. 8, 2005 (JP) 2005-11107

(51) Int. Cl. C01B 7/04; B01J 23/58; B01J 23/54; B01J 21/06; B01J 23/60; B01J 23/72

(52) U.S. Cl. 423/502; 502/328; 502/330; 502/326; 502/261; 502/332; 502/331; 502/329

(57) ABSTRACT

The present invention provides a process for producing supported ruthenium oxide comprising a step of supporting a ruthenium compound on a carrier and then calcining it in an oxygen-containing gas atmosphere, wherein the ruthenium compound has a total of each content of sodium, calcium, magnesium, iron, silicon, aluminum, copper and zinc of 500 weight ppm or less based on the amount of ruthenium.

### TECHNICAL FIELD

The present invention relates to a process for producing supported ruthenium oxide in which ruthenium oxide is supported on a carrier. In addition, the present invention also relates to a process for producing chlorine by oxidation of hydrogen chloride with oxygen by using the supported ruthenium oxide produced by the process as a catalyst.

### BACKGROUND ART

Supported ruthenium oxide is useful as a catalyst for producing chlorine by oxidation of hydrogen chloride with oxygen. As its production process, for example, EP0743277A (JP-9-67103-A) discloses that a ruthenium compound is supported on a carrier and then it is calcined in the air. In addition, EP0936184A (JP-2000-229239-A, JP-2000-254502-A and JP-2000-281314-A) discloses a process in which a ruthenium compound is supported on a carrier, it is reduced with hydrazine, sodium borohydride or the like and then oxidized, specifically, calcining it in the air. Furthermore, WO2001/010550 (JP-2002-79093-A) discloses a process in which a ruthenium compound is supported on a carrier, it is calcined in an oxidizing gas, inert gas or reducing gas, and then treated with hydrazine and thereafter oxidized, specifically, calcined in the air.

### DISCLOSURE OF THE INVENTION

The present inventor has studied in various ways the process for producing supported ruthenium oxide that includes a step of supporting a ruthenium compound on a carrier and then calcining it in an oxygen-containing gas atmosphere, and a process for producing chlorine by oxidation of hydrogen chloride with oxygen by using the supported ruthenium oxide produced by the process as a catalyst, as disclosed in the above literature. During the study, the inventor has found that specified impurities contained in a raw material ruthenium compound have effects on the catalyst performance of the resultant supported ruthenium oxide. And the inventor has found that a supported ruthenium oxide excellent in catalyst performance can be produced with good reproducibility by use of a ruthenium compound having the impurities content of a specified value or less, having led to the completion of the present invention.

The present invention provides a process for producing supported ruthenium oxide comprising a step of supporting a ruthenium compound on a carrier and then calcining it in an oxygen-containing gas atmosphere, wherein the ruthenium compound has a total of each content of sodium, calcium, magnesium, iron, silicon, aluminum, copper and zinc of 500 weight ppm or less based on the amount of ruthenium.

In addition, the present invention provides a process for producing chlorine, wherein hydrogen chloride is oxidized with oxygen in the presence of the supported ruthenium oxide produced by the above process.

According to the present invention, a supported ruthenium oxide excellent in catalyst performance can be produced with good reproducibility, and chlorine can be efficiently produced with good reproducibility by oxidation of hydrogen chloride with oxygen by using the supported ruthenium oxide thus obtained as a catalyst.

### MODE FOR CARRYING OUT THE INVENTION

The ruthenium compound used as the raw material in the present invention includes, for example, a halide such as RuCl₃ and RuBr₃, a halogeno-acid salt such as K₃RuCl₆ and K₂RuCl₆, an oxo-acid salt such as K₂RuO₄, an oxyhalide such as Ru₂OCl₄, Ru₂OCl₅ and Ru₂OCl₆, a halogeno complex such as K₂[RuCl₅(H₂O)₄], [RuCl₂ (H₂O)₄]Cl, K₂[Ru₂OCl₁₀] and Cs₂[Ru₂OC₁₄], an ammine complex such as [Ru(NH₃)₅H₂O]Cl₂, [Ru(NH₃)₅Cl]Cl₂, [Ru(NH₃)₆]Cl₂, [Ru(NH₃)₆]Cl₃ and [Ru(NH₃)₆]Br₃, a carbonyl complex such as Ru(CO)₅ and Ru₃(CO)₁₂, a carboxylate complex such as [Ru₃O(OCOCH₃)₆(H₂O)₃]OCOCH₃ and [Ru₂(OCOR)₄]Cl (R=alkyl group having 1 to 3 carbon atoms), a nitrosyl complex such as K₂[RuCl₅(NO)], [Ru(NH₃)₅(NO)]Cl₃, [Ru(OH)(NH₃)₄(NO)](NO₃)₂ and [Ru(NO)](NO₃)₃, a phosphine complex, an amine complex, an acetylacetonate complex, and the like. Of these, a halide is preferably used, and particularly chloride is preferably used. Additionally, as a ruthenium compound, its hydrate may be used according to need, and two kinds or more of it may be used.

In a ruthenium compound are normally contained impurities attributable to a raw material during its preparation, specifically, elements such as sodium, magnesium, aluminum, silicon, calcium, iron, copper, zinc, rhodium, palladium, iridium, platinum and gold as a chemical element or a compound. Depending on the kinds of their impurities, the catalyst performance of the resultant supported ruthenium oxide, particularly the performance as a catalyst for producing chlorine by oxidizing hydrogen chloride with oxygen is inversely affected. In particular, sodium, magnesium, aluminum, silicon, calcium, iron and copper are liable to decrease the catalyst performance of the resulting supported ruthenium oxide catalyst. Thus, in the present invention, as a ruthenium compound of a raw material, a ruthenium compound in which the total of each content of sodium, magnesium, aluminum, silicon, calcium, iron, copper and zinc is a specified value or less, specifically, a ruthenium compound in which the total of the contents is 500 weight ppm or less based on the amount of the ruthenium of the ruthenium compound is used. This makes it possible to produce with good reproducibility supported ruthenium oxide excellent in catalyst performance, particularly, initial activity.

In addition, albeit to lesser extents than those of the above regulated sodium, magnesium, aluminum, silicon, calcium, iron, copper and zinc, even rhodium, palladium, iridium, platinum and gold are liable to decrease the catalyst performance of the resulting supported ruthenium oxide catalyst. Accordingly, as a ruthenium compound of a raw material, it is preferable to use a ruthenium compound that satisfies the above regulation and also has the total of each content of rhodium, palladium, iridium, platinum and gold of a specified value or less, specifically, the total of 1500 weight ppm or less based on the amount of the ruthenium of the ruthenium compound.

The ruthenium compound in which the amounts of impurities are the specified values or less as mentioned above may be selected and provided from commercially available high-purity articles, or may be prepared by purifying a ruthenium compound in which the amounts of impurities exceed the specified values by means of rectification, crystallization or washing. The amounts of impurities in a ruthenium compound can be determined, for example, by inductively coupled plasma analysis (hereinafter, referred to as ICP analysis), atomic absorption analysis, ion chromatography analysis or the like. In particular, ICP analysis is preferred due to high accuracy and also a wide range of elements to be determined.

The supported ruthenium oxide is produced by supporting a ruthenium compound as mentioned above on a carrier and then calcining it in an oxygen-containing gas atmosphere. The carrier includes, for example, an oxide or a mixed oxide of elements selected from aluminum, silicon, titanium, zirconium and niobium, activated carbon, and the like. Mixtures of two or more of the carriers may be used as required. Of these, alumina, silica, titanium oxide and zirconium oxide are preferably used, and in particular, titanium oxide having the rutile crystalline structure is preferably used.

The methods for supporting a ruthenium compound on a carrier include, for example, a method of impregnating a solution of a ruthenium compound in a carrier, a method of immersing a carrier in a solution of a ruthenium compound and adsorbing the ruthenium compound in a carrier, and the like. Additionally, after supported, as required, reduction treatments may be carried out, for example, as described in Patent Documents 2 to 5.

After the ruthenium compound is supported on a carrier, the supported ruthenium oxide is produced by calcining it in an oxygen-containing gas atmosphere. As the oxygen-containing gas, air may be used or pure oxygen may be used. The calcining temperature is normally from 100 to 500° C., preferably from 200 to 400° C.

The ratio of weight of ruthenium oxide/carrier in the supported ruthenium oxide is normally from 0.1/99.9 to 20/80, preferably from 0.5/99.5 to 15/85, and the ratio of use of the ruthenium compound to the carrier may be controlled so as to be in the range. When the amount of ruthenium oxide is too small, the catalyst activity may be insufficient; when the amount is too large, the case is inadvantageous in terms of cost. Additionally, the oxidation number of the ruthenium in ruthenium oxide is normally +4 and ruthenium oxide is ruthenium dioxide (RuO₂) in this case, and ruthenium of other oxidation numbers or other forms of ruthenium oxide may be contained.

If supported ruthenium oxide thus produced is used as a catalyst and hydrogen chloride is oxidized with oxygen in the presence of the catalyst, chlorine can be efficiently produced with good reproducibility. The system of the reaction may be a fixed bed system or a fluidized bed system. Usually, a gas phase reaction such as a fixed bed gas phase distribution system or a movable bed gas phase distribution system is advantageously adopted.

The oxidation reaction is an equilibrium reaction; if the reaction is carried out at a too high temperature, the equilibrium conversion rate is decreased, therefore the reaction is preferably carried out at a relatively low temperature. The reaction temperature is normally from 100 to 500° C., preferably from 200 to 450° C. In addition, the reaction pressure is normally about from 0.1 to 5 MPa. As an oxygen source, air may be used or pure oxygen may be used. The theoretical molar amount of oxygen to hydrogen chloride is ¼ mole; however, normally, oxygen at 0.1 to 10 times of the theoretical amount is used. In addition, the supply rate of hydrogen chloride is expressed by a gas supply rate for 1L of the catalyst (L/h; 0° C., in terms of 1 atmosphere), i.e., by GHSV, and is normally about from 10 to 20000 h⁻¹.

### EXAMPLES

Hereinafter examples of the present invention will be illustrated; however, the present invention is by no means limited to those. In the examples, parts and % representing the amount of use and contents are by weight unless otherwise indicated.

### Reference Example 1

### (Preparation of a Carrier)

100 parts of an α-alumina powder [AES-12 available from Sumitomo Chemical Co., Ltd.], 50 parts of a titanium oxide powder [STR-60R available from Sakai Chemical Industry Co., Ltd., 100% rutile type] and 3 parts of methyl cellulose [Metolose 65SH-4000 available from Shin-Etsu Chemical Co., Ltd.] were mixed and then 31 parts of purified water, 20 parts of titanium oxide sol [CSB available from Sakai Chemical Industry Co., Ltd., TiO₂ content of 38%], 0.6 part of glycerin and 3 parts of polyether-based dispersing agent [Unirube 50MB-26 available from NOF Corp.] were added thereto. This mixture was extruded in a noodle form having a diameter of 3.0 mmφ and dried at 60° C. for 2 hours, and then cut into a length of about from 3 to 5 mm. The resulting molded article was heated from room temperature to 800° C. over 2.2 hours in the air and then held and calcined at the same temperature for 3 hours to obtain a white carrier composed of a mixture of titanium oxide and α-alumina.

### Example 1

### (Production of Supported Ruthenium Oxide)

Into 20.0 g of the carrier prepared in Reference Example 1 was impregnated an aqueous solution prepared by dissolving 0.747 g of ruthenium chloride hydrate [RuCl₃.nH₂O available from Furuya Metal Co., Ltd., Ru content of 41.5%] in 3.7 g of purified water and then the resulting material was left to stand at 24° C. for 15 hours. 21.1 g of the resulting solid was heated in an air flow from room temperature to 250° C. over 1.3 hours and then held and calcined at the same temperature for 2 hours to obtain 20.3 g of blue gray supported ruthenium oxide. Impurities contained in ruthenium chloride hydrate used as the raw material were determined by the ICP analysis and are shown in Table 1 as weight ratios to the ruthenium. In the table, the designation “<2” means less than 2 ppm of a lower detection limit.

### (Production of Chlorine)

1.0 g of the obtained supported ruthenium oxide was diluted with 12 g of α-alumina spherical particles having a diameter of 2 mm [SSA995 available from Nikkato Corp.] and the resulting material was loaded into a nickel reaction tube (inner diameter of 14 mm) and further in the gas inlet portion of the reaction tube was filled with 12 g of a-alumina spherical particles which is the same as the above as a preheat layer. Thereinto were supplied a hydrogen chloride gas at a rate of 0.214 mol/h (4.8 L/h in terms of 0° C., 1 atm) and an oxygen gas at a rate of 0.107 mol/h (2.4 L/h in terms of 0° C., 1 atm) at atmospheric pressure, the catalyst layer was heated to 282 to 283° C. and a reaction was carried out. In 1.5 hours after the reaction initiation, the gas from the reaction tube outlet was sampled for 20 minutes by passing it through a 30% aqueous potassium iodide solution and the amount of formation of chlorine by an iodometric titration method was measured to evaluate the formation rate (mol/h) of the chlorine. From the formation rate of the chlorine and the supply rate of the above hydrogen chloride, the conversion rate of the hydrogen chloride was calculated by means of the equation below and is shown in Table 1.

Conversion rate of hydrogen chloride (%)=[Formation rate of chlorine (mol/h)×2÷Supply rate of hydrogen chloride (mol/h)]×100

### Example 2

### (Production of Supported Ruthenium Oxide)

Into 20.0 g of the carrier prepared in Reference Example 1 was impregnated an aqueous solution prepared by dissolving 0.794 g of ruthenium chloride hydrate [RuCl₃.nH₂O available from Furuya Metal Co., Ltd., Ru content of 39.1%] in 3.7 g of purified water and then the resulting material was left to stand at 24° C. for 15 hours. 21.1 g of the resulting solid was heated in an air flow from room temperature to 250° C. over 1.3 hours and then held and calcined at the same temperature for 2 hours to obtain 20.3 g of blue gray supported ruthenium oxide. Impurities contained in the ruthenium chloride hydrate used as the raw material were determined by the ICP analysis and are shown in Table 1 as weight ratios to the ruthenium.

### (Production of Chlorine)

Chlorine was produced in the same manner as Example 1 by use of the obtained supported ruthenium oxide as a catalyst. The conversion rate of the hydrogen chloride is shown in Table 1.

### Comparative Example 1

### (Production of Supported Ruthenium Oxide)

Into 20.0 g of the carrier prepared in Reference Example 1 was impregnated an aqueous solution prepared by dissolving 0.775 g of ruthenium chloride hydrate [RuCl₃.nH₂O available from N. E. Chemcat Corp., Ru content of 40.0%] in 3.7 g of purified water and then the resulting material was left to stand at 24° C. for 15 hours. 21.1 g of the resulting solid was heated in an air flow from room temperature to 250° C. over 1.3 hours and then held and calcined at the same temperature for 2 hours to obtain 20.3 g of blue gray supported ruthenium oxide. Impurities contained in the ruthenium chloride hydrate used as the raw material were determined by the ICP analysis and are shown in Table 1 as weight ratios to the ruthenium.

### (Production of Chlorine)

Chlorine was produced in the same manner as Example 1 by use of the obtained supported ruthenium oxide as a catalyst. The conversion rate of the hydrogen chloride is shown in Table 1.

TABLE 1

| | | Examples | | | | | |
|---|---|---|---|---|---|---|---|
| | | | | | | Comparative | |
| | | Example 1 | | Example 2 | | Example 1 | |
| Weight | Na | 210 | 246 | 72 | 120 | 155 | 584 |
| ratio/Ru | Mg | 26 | | 15 | | 88 | |
| (ppm) | Al | <2 | | <2 | | 208 | |
| | Si | <2 | | 15 | | 25 | |
| | Ca | 5 | | 5 | | 8 | |
| | Fe | <2 | | 5 | | 90 | |
| | Cu | <2 | | <2 | | 5 | |
| | Zn | 5 | | 8 | | 5 | |
| | Rh | 111 | 319 | 412 | 1805 | <2 | <10 |
| | Pd | 41 | | 210 | | <2 | |
| | Ir | 36 | | 443 | | <2 | |
| | Pt | 96 | | 502 | | <2 | |
| | Au | 39 | | 238 | | <2 | |

| | | | |
|---|---|---|---|
| Conversion rate of | 9.8 | 9.4 | 9.1 |
| Hydrogen Chloride (%) | | | |

### Reference Example 2

### (Preparation of a Carrier)

100 parts of an a-alumina powder [AES-12 available from Sumitomo Chemical Co., Ltd.], 100 parts of a titanium oxide powder [STR-60R available from Sakai Chemical Industry Co., Ltd., 100% rutile type] and 4 parts of methyl cellulose [Metolose 65SH-4000 available from Shin-Etsu Chemical Co., Ltd.] were mixed and then 50 parts of purified water and 26 parts of titanium oxide sol [CSB available from Sakai Chemical Industry Co., Ltd., TiO₂ content of 38%] were added thereto. This mixture was extruded in a noodle form having a diameter of 1.5 mmφ and dried at 60° C. for 2 hours, and then cut into a length of about from 3 to 5 mm. The resulting molded article was heated from room temperature to 630° C. over 2 hours in the air and then held and calcined at the same temperature for 3 hours to obtain a white carrier composed of a mixture of titanium oxide and α-alumina.

### Example 3

### (Production of Supported Ruthenium Oxide)

Into 20.0 g of the carrier prepared in Reference Example 2 was impregnated an aqueous solution prepared by dissolving 1.699 g of ruthenium chloride hydrate [RuCl₃.nH₂O available from Furuya Metal Co., Ltd., Ru content of 37.3%] in 4.1 g of purified water and then the resulting material was left to stand at 24° C. for 15 hours. 20.1 g out of 21.1 g of the resulting solid was taken, and was heated in an air flow from room temperature to 250° C. over 1.3 hours and then held and calcined at the same temperature for 2 hours to obtain 18.9 g of blue gray supported ruthenium oxide. Impurities contained in the ruthenium chloride hydrate used as the raw material were determined by the ICP analysis and are shown in Table 2 as weight ratios to the ruthenium.

### (Production of Chlorine)

Chlorine was produced in the same manner as Example 1 by use of the obtained supported ruthenium oxide as a catalyst. The conversion rate of the hydrogen chloride is shown in Table 2.

### Example 4

### (Production of Supported Ruthenium Oxide)

Into 20.0 g of the carrier prepared in Reference Example 2 was impregnated an aqueous solution prepared by dissolving 1.536 g of ruthenium chloride hydrate [RuCl₃.nH₂O available from Furuya Metal Co., Ltd., Ru content of 39.1%] in 4.1 g of purified water and then the resulting material was left to stand at 24° C. for 15 hours. 19.8 g out of 21.8 g of the resulting solid was taken, and was heated in an air flow from room temperature to 250° C. over 1.3 hours and then held and calcined at the same temperature for 2 hours to obtain 18.9 g of blue gray supported ruthenium oxide. Impurities contained in the ruthenium chloride hydrate used as the raw material were determined by the ICP analysis and are shown in Table 2 as weight ratios to the ruthenium.

### (Production of Chlorine)

Chlorine was produced in the same manner as Example 1 by use of the obtained supported ruthenium oxide as a catalyst. The conversion rate of the hydrogen chloride is shown in Table 2.

### Comparative Example 2

### (Production of Carried Ruthenium Oxide)

Into 80.0 g of the carrier prepared in Reference Example 2 was impregnated an aqueous solution prepared by dissolving 6.079 g of the ruthenium chloride hydrate used in Comparative Example 1 [RuCl₃.nH₂O available from N. E. Chemcat Corp., Ru content of 40.0%] in 14.5 g of purified water and then 50.0 g out of 100.7 g of the resulting material was taken and left to stand at 24° C. for 15 hours. 21.1 gout of 43.8 g of the resulting solid was taken, and was heated in an air flow from room temperature to 250° C. over 1.3 hours and then held and calcined at the same temperature for 2 hours to obtain 20.8 g of blue gray supported ruthenium oxide. Impurities contained in the ruthenium chloride hydrate used as the raw material were determined by the ICP analysis and are shown in Table 2 as weight ratios to the ruthenium.

### (Production of Chlorine)

Chlorine was produced in the same manner as Example 1 by use of the obtained supported ruthenium oxide as a catalyst. The conversion rate of the hydrogen chloride is shown in Table 2.

TABLE 2

| | | Examples | | | | | |
|---|---|---|---|---|---|---|---|
| | | | | | | Comparative | |
| | | Example 3 | | Example 4 | | Example 2 | |
| Weight | Na | 271 | 472 | 46 | 117 | 155 | 584 |
| ratio/Ru | Mg | 66 | | 34 | | 88 | |
| (ppm) | Al | 27 | | 4 | | 208 | |
| | Si | 66 | | <2 | | 25 | |
| | Ca | 15 | | 10 | | 8 | |
| | Fe | 21 | | 17 | | 90 | |
| | Cu | 4 | | 2 | | 5 | |
| | Zn | 2 | | 4 | | 5 | |
| | Rh | 2 | 16 | <2 | 12 | <2 | <10 |
| | Pd | 7 | | 7 | | <2 | |
| | Ir | 2 | | <2 | | <2 | |
| | Pt | <2 | | <2 | | <2 | |
| | Au | 5 | | 5 | | <2 | |

| | | | |
|---|---|---|---|
| Conversion rate of | 17.1 | 16.9 | 16.0 |
| Hydrogen Chloride (%) | | | |

### INDUSTRIAL APPLICABILITY

According to the present invention, a supported ruthenium oxide excellent in catalyst performance can be produced with good reproducibility, and chlorine can be efficiently produced with good reproducibility by oxidation of hydrogen chloride with oxygen by use of the supported ruthenium oxide thus obtained as a catalyst.

1. A process for producing supported ruthenium oxide, comprising a step of supporting a ruthenium compound on a carrier and then calcining it in an oxygen-containing gas atmosphere, wherein the ruthenium compound has a total of each content of sodium, calcium, magnesium, iron, silicon, aluminum, copper and zinc of 500 weight ppm or less based on the amount of ruthenium.

2. The process according to claim 1, wherein
a total of each content of rhodium, palladium, iridium, platinum and gold in the ruthenium compound is 1500 weight ppm or less based on the amount of ruthenium.

3. A process for producing chlorine, wherein
hydrogen chloride is oxidized with oxygen in the presence of the supported ruthenium oxide produced by the process according to claim 1 or 2.
